(19) United States
(12) Patent Application Publication
(10) Pub. No.: US 2004/0064386 A1
(43) Pub. Date: Apr. 1, 2004

(54) Real time claim processing system and method

(76) Inventors: Jane Goguen, Oakville (CA); Darren Willson-Rymer, Toronto (CA); Kathleen Connolly, Fairfax Station, VA (US); Michael Schmidt, Etobicoke (CA); Julie Demers, Outremont (CA); Vincent Loparo, Madison, OH (US)

Correspondence Address: DOWELL & DOWELL, 1215 JEFFERSON DAVIS HWY, SUITE 309, ARLINGTON, VA, 22202-3124, US

(21) Appl. No.: 10/260,337

(22) Filed: Oct. 1, 2002

(51) Int. Cl. G06F 17/60

(52) U.S. Cl. 705/34

(57) ABSTRACT

A real time claim processing system, the system comprising: an electronic claim submission interface; an eligibility processor of claim data supplied through the claim interface; a repricing processor for repricing the claim data; an adjudication processor for adjudicating the repriced claim data to provide adjudication details; and a payment processor for providing payment details of the adjudicated claim; wherein a real time response is provided to a provider of the claim data supplying adjudication and payment details.

### BACKGROUND OF THE INVENTION

1. Field of the Invention

The present invention relates to electronic bill submission and processing, and in particular to insurance claims corresponding to providers of insurance services.

2. Description of the Prior Art

It is recognised in the health care industry that in order to service patient population, health care providers, by necessity, have become participants in many networks. This requires the complex management of many fee schedules, a process that is commonly outside of the capabilities of most practice management systems. The process is then left up to the payer, or each of the networks, creating further delays and added costs to health plans. Further, it is recognised that there are many industry efforts in place to reduce cost, as well as constant Federal and State legislative changes, and electronic transaction code sets, and privacy and security requirements. Therefore, health claims processing has become a costly and time consuming endeavor in the current health care industry.

For example, the current healthcare claims system is the source where inefficiencies contribute in administrative overhead and delays. Furthermore, providers are suffering from a bad debt expenses on patient payment amounts. In addition the current medical claims system is fraught with the high potential for errors and omissions resulting in more cost to process. Providers realise that the reduction of their Account Receivables balance and reconciliation time is desirable This can happen through more direct eligibility verification, streamlined management of many network relationships, and faster payment. For payers, the key to more efficient plan management is increasing their membership. This can happen through a value proposition which includes increasing auto-adjudication rates by reducing rejected claims and eliminating many of the steps required in order to accomplish today's claims administration. This requires the implementation of a rules based engine, an engine flexible enough to implement new plan/benefits rapidly and at low costs

It is an object of the present invention to provide a real time claims processing system to obviate or mitigate some of the above-presented disadvantages.

### SUMMARY OF THE INVENTION

According to the present invention there is provided a real time claim processing system, the system comprising: a) an electronic claim submission interface; b) an eligibility processor of claim data supplied through the claim interface; c) a repricing processor for repricing the claim data; d) an adjudication processor for adjudicating the repriced claim data to provide adjudication details; e) and a payment processor for providing payment details of the adjudicated claim; wherein a real time response is provided to a provider of the claim data supplying adjudication and payment details.

### BRIEF DESCRIPTION OF THE DRAWINGS

These and other features of the preferred embodiments of the invention will become more apparent in the following detailed description in which reference is made to the appended drawings wherein:

FIG. 1 is a diagram of a closed loop claims processing system;

FIG. 2 shows further details of the system of FIG. 1;

FIG. 3 provides further details of the workflow of FIG. 2;

FIG. 4 provides further details on the platform of FIG. 2;

FIG. 5 is an example repricing operation of the syetm of FIG. 2; and

FIG. 6 is a further embodiment of the repricing of FIG. 5.

### DESCRIPTION OF THE PREFERRED EMBODIMENTS

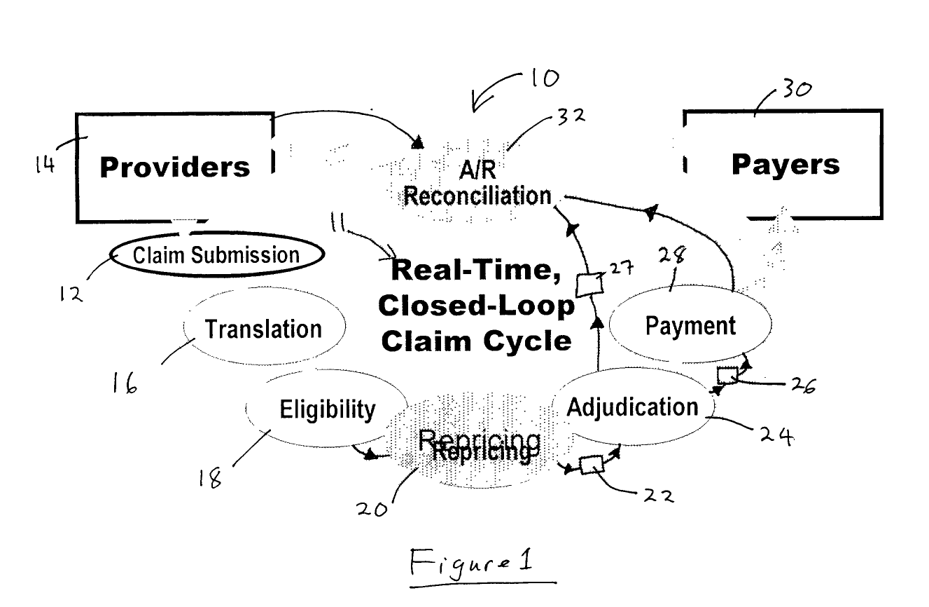

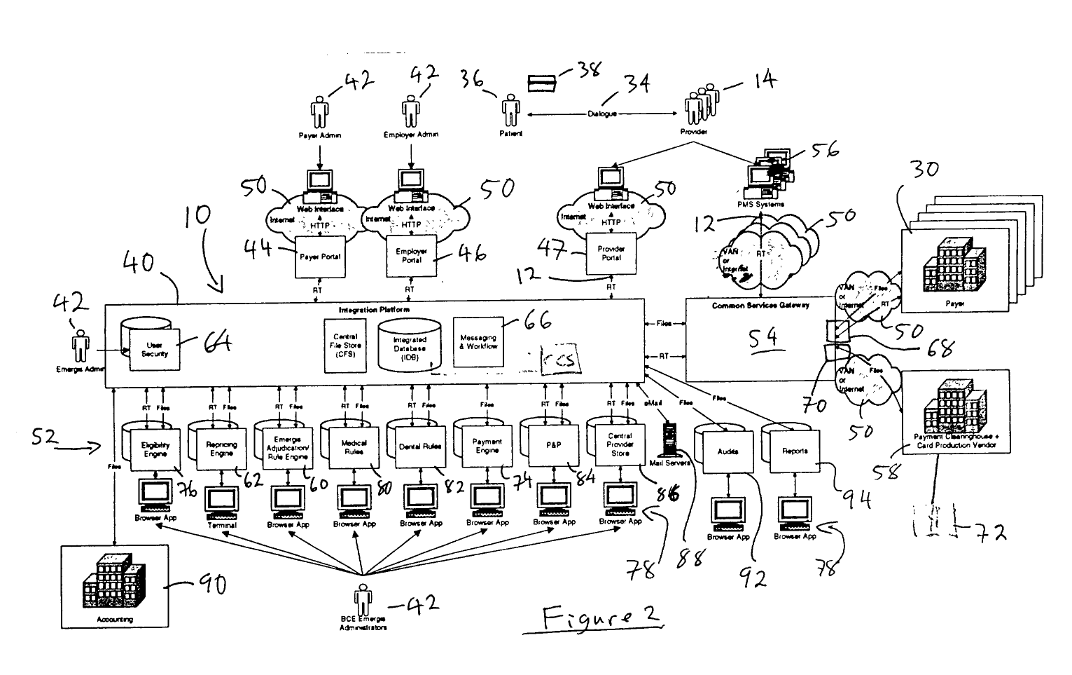

Referring to FIG. 1, a closed loop claims management system 10 (see also FIG. 1) processes 11 electronically submitted claim data 12 sent by a provider 14 of insured services, such as but not limited to health, dental, vision, and drug. The provider 14 is a user of the system 10, can give medical services to a patient 36 (see FIG. 2), and can initiate the claim data 12 transactions. The patient 36 is a user of the system 10 who has benefits with a payer 30 and can receive treatment from the provider 14. The payer 30 is a user of the system 10, and can be an insurance company supporting the delivery of medical services to the patient 36. The claim process 11 of the system 10 has a translation sub-process 16 that translates the claim data 12 to a standard system 10 format. The claim process 11 also has an eligibility sub-process 18 that checks the eligibility of the claim data 12, such as but not limited to patient details, provider details, and services details. The eligibility sub-process 18 can confirm if the patient 36 is covered (i.e. part of an insurance plan), can be done in real time, and can be integrated in an enrolment process (not shown) of the patients 36 and a payer 30. Once eligible, the claim data 12 is sent to a repricing sub-process 20 for repricing to determine an agreed upon dollar amount for the insured services. Repriced claim data 22 is then sent to an adjudication sub-process 24 for adjudication, which processes the repriced claim data 22 according to business rules to determine what portion of the repriced claim data 22 should be paid out, if any. The adjudication sub-process 24 generates adjudication results for a valid completed claim 26, and generates exception records for an invalid exception claim 27, as further discussed below.

The completed claim 26 is then sent to a payment sub-process 28 for (eventually to the payer 30) for payment processing according to a payment clearing schedule, and is also sent back to the provider 14 as feedback in real time to indicate the dollar amount of the completed claim 26, as well as any corresponding adjudication details. The exception claim 27 is also sent in real time back to the provider 14, to indicate that the originally submitted claim data 12 is not acceptable. The provider 14 can also access an Accounts Receivable (A/R) sub-process 32 for obtaining more detailed information about the processed claims 26, 27, such as payment and adjudication details. The sub-process 32 also allows the provider 14 to check on the status of the claim data 12 if the processed claims 26 cannot be settled in real time, as further described below. Accordingly, the system 10 and process 11 facilitate the provider 14 to obtain, in real time, adjudication and payment details for patient services/products. It is recognised that the system 10 could also supply real time EOB/EOP for the providers 14, which could be given to the patients 36 at the point of sale of the insured services/products, thereby providing electronic point-of-sale connectivity.

Referring to FIG. 2, the system 10 allows the provider 14 to have a dialogue 34 with a patient 36, concerning insured services given to the patient 36 by the provider 14, and then process 11 in real time the agreed upon services/products to determine service and payment details, as acceptable by the payer 30. The patient 36 may have a swipe card 38 to facilitate the eligibility and adjudication sub-processes 18, 24 (see FIG. 1) to help settle the claim data 12, either completed or proposed, in real time claim transactions (hereafter referred to as RT for real time submission, processing, and response to the claim data sets 12). This is as compared to file transactions (FT), which are data sets that are typically not processed in real time and are instead batch processed according to an agreed upon (by the users) periodic cycle. Both the RT and files or FT are commonly referred to as messages both transmitted and received within and outside of the system 10, i.e. RT messages relate to real time claim information and FT messages relate to offline claim related and system 10 information. The swipe card 38 can be an optional component connected to a PMS system 56, for example, for pre-population of the PMS software. The card 38 can provide eligibility information for the PMS software (for example), be used as a credit card to pay for services, and can trigger the electronic submission of the claim data 12. Other pre-population data stored on the swipe card 38 can include member (such as dental service providers) and provider 14 information. The swipe card 38 can also provide eligibility information to other parts of the system 10, as a measure for risk sharing of the claims process 11.

Referring again to FIG. 2, the system 10 has an integration platform 40 for connecting the providers 14 and administrators 42 (through a payer portal 44, an employer portal 46, and a provider portal 47) over networks 50 (such as private networks or the Internet) to a plurality of individual processing components 52 of the system 10, as further described below. The platform 40 also connects the components 52 and the portals 44, 46, 47 to a common services gateway 54, which is connected to the PMS systems 56, the payers 30, and a payment clearing house 58.

The payer portal 44, connected to the platform 40, is used by the payer 30 to interface with all of the components 52 in the system 10. The payer portal 44 supports administration that the payer 30 may require, such as but not limited to inquiry, member claim processing, enrolment, service code management, plan management, and provider management. Accordingly, the payer 30 can use the portal 44 to supply repricing data, group and member data, service code data, claims history data, and provider data for storage in an integrated database IDB of the platform 42 and subsequent usage by the components 52 of the system 10. It is noted that the service codes define the insured services according to a standardized set of services/products recognised by the system 10. The service codes are part of the claim data 12 and are used by the adjudication sub-process 24 (see FIG. 1).

The employer portal 46, connected to the platform 40, helps employers to keep enrollment records up to date for their employees that are patients 36, to submit claims 12 on behalf of members, and to inquire against claim activity stored within the IDB. The provider portal 47 allows the providers 14 to support claim, eligibility, inquiry and payment reconciliation 32 capabilities. The portal 47 can be a single point of access to the system 10 for multiple providers 14, however, it is recognised there can be more than one portal 47, if desired. The portal 47 supports such as but not limited to medical, paramedical, dental, vision, and hospital claims 12. The portal 47 has sign-on functionality to support a plurality of providers 14, whereby the providers 14 can submit clams 12, submit voids, receive functional acknowledgements of the claims processing, receive remittance advice, conduct claim inquiries, and conduct payment reconciliation 32 inquiries. The portal 47 therefore allows the providers 14 to submit claims, as well as claim predeterminations to the platform 40, which routes the claim data 12 to appropriate components 52 for processing 11, as further explained below.

The portal 47 also allows the providers 14 to check for eligibility 18, prior to performing any insured services, to confirm whether the patient 36 does have coverage by the payer 30. This feature can help in situations such as but not limited to checking on effective coverage dates, as well as confirming whether coverage has been updated for a dependent of the patient 36. For non-coverage situations, the provider 14 can request direct payment from the patient 36 at the time of performing the insured services/products. The claim inquiry function of the portal 47 allows the provider 14 to view previously submitted transactions, either as RTs or FTs (or RTs classified by the system 10 as FTs) containing the claim data 12. The providers 14 can also use the portal 47 to search through a list of patients 36 when having only a limited set of patient 36 information. The portal 47 can also support service code lookups to help the providers 14 submit their claim data 12. The service codes can be located in the IDB and updated by the administrators 42 as required. The portal 47 can also support patient 36 lookup for entering patient records for pre-population of the claim forms to create the claim data 12 for submission to the platform 40.

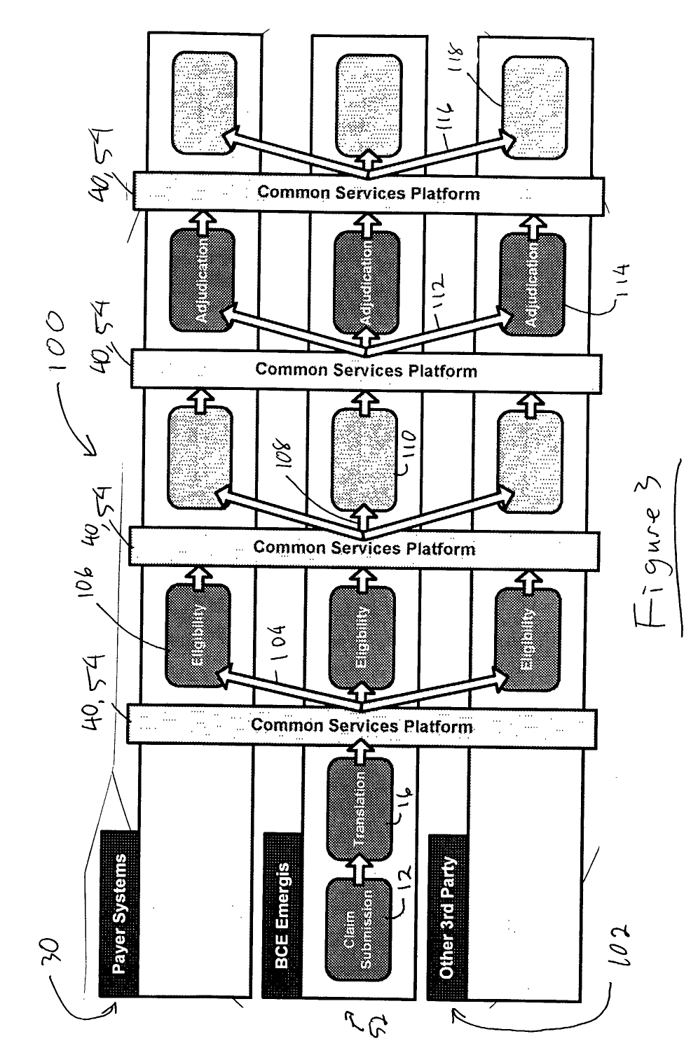

The common services gateway 54 facilitates communication between various processing partners 30, 58 of the system 10 and the platform 40, by implementing message passing, message translation, and message queuing. The gateway 54 supports FT communication/messaging for providing a payment file to the payment vendor 58, a confirmation file from the payment vendor 58, a claim file to the payer 30, and an eligibility file from the payer 30. Example implementations of the FT communications are, such as but not limited to; access by the payer 30 to terminals of an adjudication engine 60 through telnet, access by the payer 30 to terminals of a repricing engine 62 through telnet, and send and receive files by the payer 30 through FTP. Further, the payment vendor 58 can send and receive files through FTP. In addition, the common gateway 54 allows for sharing of the claim processing (see FIG. 1) services by a plurality of parties, as further explained below with reference to FIG. 3. The common gateway 54 also establishes network connectivity for each PMS system 56 and for each payer 30 through the networks 50. The adjudication engine 60 performs the adjudication 24, and the repricing engine 62 performs the repricing 20 (see FIG. 1), as further explained below. Accordingly, the gateway 54 can also facilitate the communication between various processing partners 30, 58 of the system 10 and the platform 40 for passing of the RTs in relation to processing 11 of the claim data 12 (see FIG. 3).

The PMS system 56 uses industry compliant message sets and sends claims, eligibility, and inquiry requests to the common services gateway 54 in real time. A workflow engine 66 in the integration platform 40 routes and manages the RTs received from the PMS system 56 for repricing 20 and adjudication 24, as further explained below. The payer 30 also transmits and receives files through the gateway 54. A payer interface 68 is used to receive eligibility data files from the payer 30 and transmit claim files to the payer 30. The payer interface 68 can also be used for batch processing of files FT. The payer interface 68 is also used by the payer 30 to receive and transmit RT through the gateway 54. The payment and card production vendor 58 also communicates to the system 10 through the gateway 54. A vendor interface 70 is used to such as but not limited to send ACH files, send cheques and EOB files, to send production files, and to receive confirmation files. The automated clearing house (ACH) function of the vendor 58 helps to direct EFT payments to multiple financial institutions 72, preferably in the form of FTs, which provide physical payment to the providers 14 subsequent to the real time confirmation of the submitted claims 12 through the RTs. It is recognised that the physical payment could also be sent in real time as well, for example included in the RTs and processed claims 26 information, if desired.

Referring again to FIG. 2, common gateway 54 interacts with the integration platform 40, which is a combiner for all system 10 components 52 to facilitate communication there-between. The platform 40 provides a consolidated view of the claim data 12 during various stages of claims processing, and can also provide security services 64 to administer and manage security privileges for all users of the system 10. The platform 40 also uses the workflow engine 66 to provide switching and workflow logic to receive messages, translate, and route these messages to processing components of the system 10, such that the RT and files get sequentially routed for processing after receiving the initial claim data 12. The integrated database (IDB) of the platform 40 stores a consolidated picture of claim data 12, eligibility data, product and price data, provider data, and claim adjudication/payment details. The IDB also has a central claim store (CCS) for access by claim inquiries made through the portals 44, 46, 47, and by the payers 30. A central file store (CFS) of the platform 40 is a physical device where all the files used in communication between the various system 10 components are stored. The CFS helps to provide audit trail capabilities for the files, for example both FT and RT.

Referring again to FIG. 2, the messaging of the workflow engine 66 supports queuing for the components 52 of the system that cannot be reached at a certain point in the claim processing 11 workflow (such as due to component and/or network failure). Accordingly, the workflow engine 66 routes RT and FTs as claims, voids, inquiries, and eligibility requests from the various portals 44, 46, 47 and the PMS system 56, according to workflow rules that indicate where the claim data 12 is acted upon by the components of the system 10 to be repriced 20, adjudicated 24, paid 28, among other functions. The workflow engine 66 also manages the RT that require repricing 20 and adjudication 24, as well as those RT that require repricing 20 only. For example, the workflow engine 66 sends eligibility data and provider data to the adjudication engine 60, both as RTs and FTs, as well as receives asynchronous adjudication results as FT (preferably) from the adjudication engine 60 for storing in the IDB. The workflow engine 66 also supports timeout checking and subsequent claims processing 11 through queuing, as well as manages inquiry transactions between the IDB and the users of the system 10 using the portals 44, 46, 47. The workflow engine 66 also performs message translations through the sub-process 16, such as but not limited to ANSI.X12 837 to adjudication engine 60 claims, adjudication engine 60 acknowledgement to ANSI.X12 997, adjudication engine 60 remittance advice to ANSI.X12 835, ANSI.X12 270 to adjudication engine 60 eligibility, adjudication engine 60 to ANSI.X12 271, and claim inquiry to adjudication engine 60 inquiry.

The workflow engine 66 also supports payment sub-process 28 flows, by synchronizing the adjudication engine 60 and the CCS, by synchronizing the repricing engine 62 and the CCS, by updating the IDB for marking claims as paid when needed, by creating a payment file based on data in the CCS, by sending the payment file to the payment vendor 58 via the common gateway 54, and by picking up a confirmation file from the payment vendor 58 via the common gateway 54. The workflow engine 66 also passes adjudicated claims to the payment engine, receives paid claims from a payment engine 74, receives the ACH file from the payment engine 74, implements workflow to route the ACH file, receives the cheque/EOB file from the payment engine 74, and receives a reconciliation file. The workflow engine 66 also supports the payer portal 44, by creating a claims file, by sending the claims file to the payer 30 via the gateway 54, by receiving an eligibility file from the payer 30 via the common gateway 54, by passing the RT to the payer 30 for adjudication when required, by receiving RT from the payer 30 for payment, by receiving a file of claims (i.e. non-real time) from the payer 30 for payment, by receiving RT claims from the payer 30 for repricing, and by receiving a file of claims from the payer 30 for repricing. The workflow engine 66 also supports internal administration by implementing process flows to create a claims file, to receive a corrections file from the administrators 42, and to reconcile corrections against the CCS. Accordingly, the workflow engine 66 facilitates message transfer in the form of RTs and/or FTs through the system 10, based on prearranged protocols by the users of the system 10.

Referring to FIG. 2, the platform 40 coordinates the processing 18, 20, 24, 28 of the claims 12 between the various components 52, as given in FIG. 1. The components 52 are monitored for performance and data content/ software updates via a number of browsers 78. An eligibility engine 76 of the components 52 is a rules engine for eligibility requests. Once the claim data 12 has been cleared for eligibility, the repricing engine 62 of the components 52 supports the repricing 20. Repricing 20 can be considered as the gatekeeper for the adjudication 24 and the payment 28 processes. The repricing engine 62 receives and processes RTs according to preagreed upon provider network contracts, as further explained below. The repricing engine 62 also receives uploads/downloads of repricing rules through the communication of the files, preferably FTs. The repricing 20 capabilities of the repricing engine 62 include automated repricing, web repricing, and real time repricing. The repricing engine 62 interfaces with machine-to-machine communications, file based interfaces with output files available in real time (RTs), and a web form to enter data and view returned results to provide feedback to the users, such as the providers 14, of repricing 20 information based on the submitted claim data 12. It should be noted that the repricing sub-process 20 has been isolated from the adjudication sub-process 24, thus allowing different suppliers to implement either the repricing 20 and/or the adjudication 24 sub-processes separately, see FIG. 3.

The adjudication engine 60 of the components 52 is a rules based engine that processes claims 12 and voids in real time (i.e. RT), as well as supplying files of asynchronous adjudication results to the platform 40 for inclusion into the IDB for any claim 12 that could not, for whatever reason, be processed as an RT. Therefore, asynchronous or non-real time claim results can be avoided by informing the provider 14 the claim data 12 has been placed in pending status with a corresponding claim number in the claim results 26. Accordingly, if the claims 12 cannot be adjudicated in real time, then the provider 14 gets an “accepted” status back with the claim results 26, with the claim 12 being either slated for further processing in the queue by the workflow engine 66, or for manual intervention potentially by the administrators 42. In either event, the provider 14 can access the IDB with the claim 12 number to follow the progress of the non-real time claim through the offline processing.

Therefore, the claim 12 can have one of two submission states, either accepted 26 or rejected 27. The claim 12 can have one of the following adjudication states, complete, declined, voided, or pended. The claim 12, once completed, can be in one of the following paid states; ready for payment or paid. Further, it is considered that some of the payer 30 functions can be performed by the system 10. This can depend on the comfort level of the payer 30 in use of the system 10 in a short time frame and the ability to supply the payer 30 with tools that can be operated from their site. These payer 30 functions include Plan setup, Group Setup and Inquiry.

Further, the adjudication engine 60 provides plan administration (set up by the payers 30), multi-benefit claim 12 processing for such as but not limited to medical, dental, and flexible benefits (HAS) and/or standard benefits, as well as report generation to provide claim adjudication/payment details. The adjudication engine 60 receives a file of providers 14, a file of service codes, and U&C pricelists from the platform 40 for updating the adjudication rule set, as well as uploads/downloads of adjudication rules through communication of the files. It is noted that the workflow logic of the adjudication engine 60 is modified to allow for external adjudication 24 to the repricing 20 sub-process. It should be noted that the functions of the adjudication 24 (see FIG. 1) have been isolated into separate components 52 to allow distribution of the claim processing 11 across different components 52 through the common gateway 54, as shown in FIG. 3.

Referring again to FIG. 2, the payment engine 74 of the components manages the timing of payment requests according to the payment terms for each payee (i.e. patient 36/provider 14 that receives payment due to the adjudication 24). The payment engine 74 receives a file of paid claims (i.e. from the payment 28 function) from the platform 40, and provides a file of ACH payments on a periodic basis, such as nightly, as well as a cheque/EOB or EOP file, i.e. explanation of benefits/payment. The payment engine 74 communicates mostly with the payer 30 and the payment vendor 58, as well as for payment inquiries from the portals 44, 46, 47.

Referring again to FIG. 2, other components 52 include a medical rules 80 as a repository of soft tissue protocols and can be used during the adjudication 24 as a value added service. A dental rules 82 component is a repository of dental practice rules and can be used during the adjudication 24 process as a value added service. A product and price 84 component is an administration tool of the system 10 that acts as a repositiory of service codes and pricelists. A central provider store 86 component is an administration tool of the system 10 that helps to manage all provider data, such as related to enrolment and registration, and is used to supply the provider data as files to the adjudication engine 60. The provider data management helps the payers 30 for maintaining their payment systems. A mail server 88 can receive SMTP requests from the platform 40 informing the administrators 42 of key events in response to the management and processing activities of the system 10. An accounting component 90 is used to create periodic reports, such as nightly, to provide accounting information to support the invoice/billing process between the providers 14, the payers 30 and the clearing house 58.

Further, also connected to the platform 40 is an audit system 92 used to review processed claims 26, 27 and to help ensure correct use of the system 10 by all the users. The audit system 92 provides an analysis and case management tool. For example, the audit system 92 queries on a periodic basis selected electronic claims 12, by asking for paper confirmations and monitoring out of range activities. The system 92 can create normative data. A reporting tool 94 creates, manages, and publishes reports for the users of the system 10 The reports can provide usage as well as normative analysis.

Referring to FIG. 3, the workflow 100 is shown for processing 11 the submitted claim 12 once translated 16 and then submitted to the platform 40 through common gateway 54, is required. The platform/gateway 40,54 allows the workflow engine 66 (see FIG. 2) to control the sequential processing steps 18, 20, 24, 28 (see FIG. 1) between the components 52, a series of components (not shown) for one of the payers 30, and the components (not shown) for another third party 102. For example, once translated 16, the submitted claim 12 could be sent 104 to the payer 30 systems for eligibility processing 106, and then sent 108 for repricing 110 by the components 52, then sent 112 for adjudicating 114 by the third party 102, and then sent 116 for payment processing 118 also by the third party 102 systems. In any event, the workflow engine 66 controls the flow 104, 108, 112, 116 of the claim 12 processing 11 between the various systems 30, 52, 102 as agreed upon by the parties 30, 52, 102 for processing 11 of particular claims 12. This type of processing 11 by multiple parties 30, 52, 102 is advantageous when each of the parties 30, 52, 102 has a particular requirement to perform one or more of the processing steps 18, 20, 24, 28 (see FIG. 1). The use of the RTs and FTs for messaging to and from the central file store CFS helps the workflow engine 66 manage the processing workflow 100. It is recognised that some steps 104, 108, 112, 116 of the process flow 100 may be switched between various components 52 that are directly connected to the platform 40, hence not needing the routing capabilities of the gateway 54.

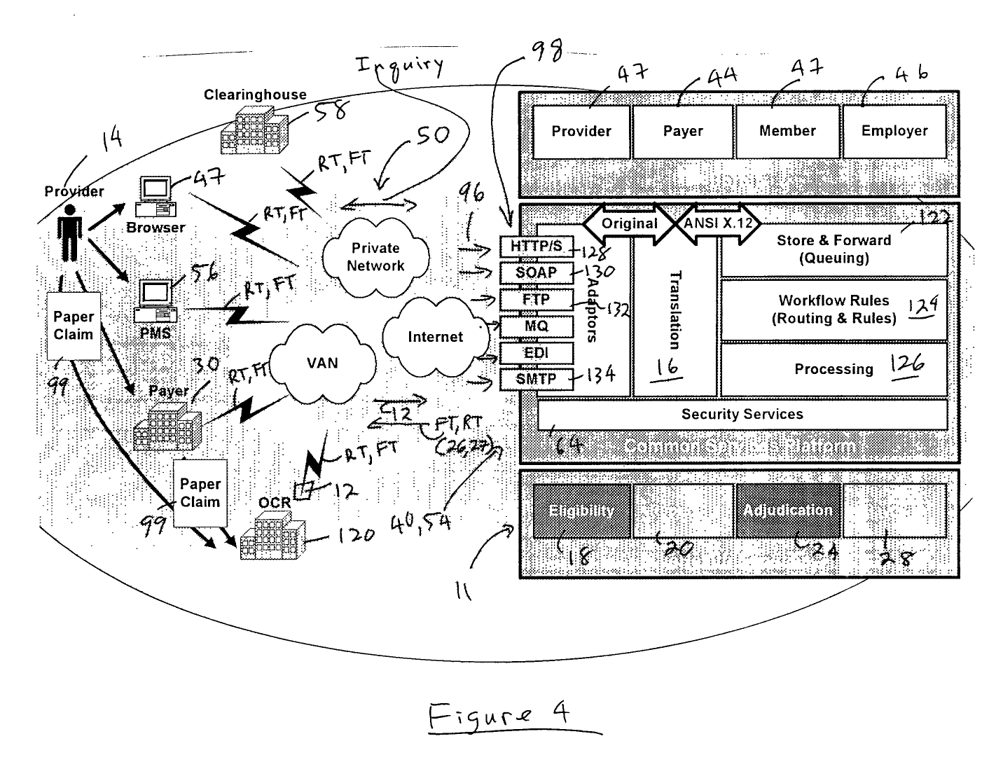

Referring to FIG. 4, the workflow engine 66 (see FIG. 2) operates on receiving various messages 96 related to claims 12 processing 11 and other system information related to claims processing 11. This information is collected from the networks 50 and provided to a series of ports 98, or messaging interface. The ports 98 help the workflow engine 66 differentiate between which messages 96 are RTs and which are FTs. The use of which port 98 by the various users 14, 58, 30 of the system 10 is agreed upon prior to processing 11 of the claim data 12 contained in the messages 96. It is noted that for paper claims 99, an optical character recognition system 120 can supply the electronic claim data 12. It is noted that both the platform 40 and gateway 54 initially receive the messages 96, or just the platform 40, depending upon the connectivity of the users 14, 58, 30 to the system 10. In any event, the workflow engine 66 receives the messages 96 through the ports 98 for translation processing 16 before interacting through a store and forward queuing protocol 122, a workflow routing and rules protocol 124, and a processing protocol 126 to process 11 the claim data 12 contained within the messages 96 through the various sub-processes 18, 20, 24, 28 as described above. Accordingly, the protocols 122, 124, 126 guide the progression of the submitted claim data 12 through the process 11, as RTs to deliver the processed claims 26, 27, or as FTs for such as but not limited to system data updates, payment files sent to the clearinghouse 58, and inquiries on pending status claims as described above. Further, the protocols 122, 124, 126 administer the content of the CFS, CCS, and IDB for access by the users 14, 30, 58 for inquiry purposes.

Referring to FIG. 4, an HTTP/S port 128 allows for RT messaging 96 in the form of text, images, and video as a web based communication protocol for the claim data 12 and processed claims 26, 27. A SOAP port 130 can also be used to deliver RT messages 96, such as for system to system communication. An FTP port 132 can be used as a one-way data communications for FT messages 96. An SMTP port 134 also can be used for one-way data communications for FT messages 96. It is recognised that the ports 132, 134 can be used by the system 10 to provide information to the mail server 88 (see FIG. 2). Accordingly, the use of different port 98 types (FT or RT) by the system 10 helps the workflow engine 66 in the timely generation of spawning the various sub-processes 18, 20, 24, 28 separately from those processes more suited to FTs.

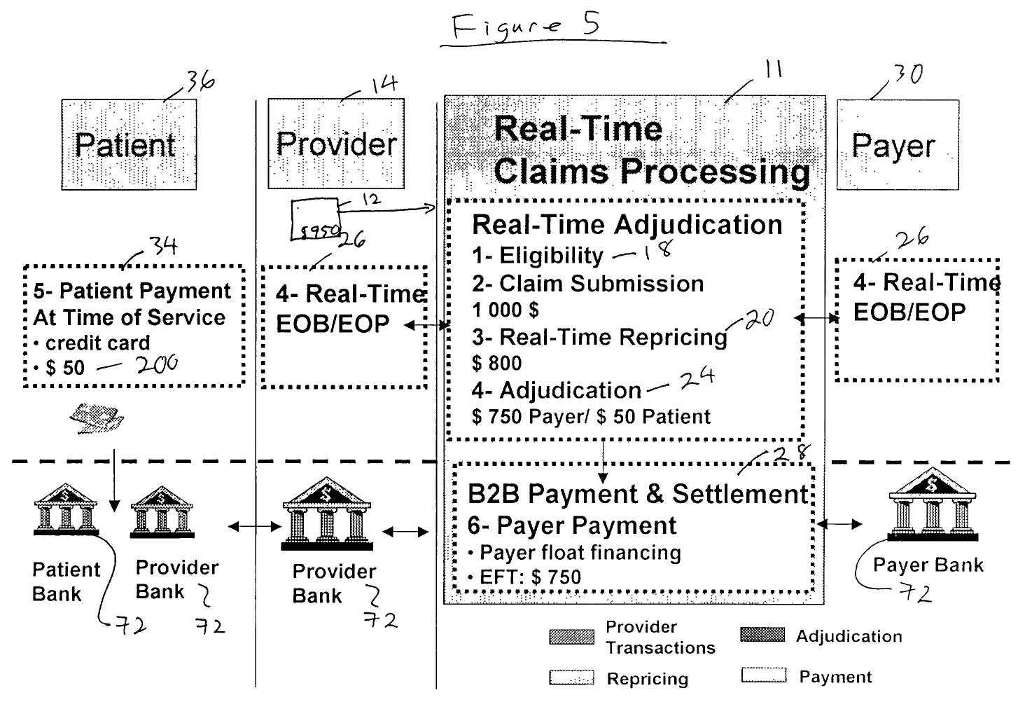

Referring to FIGS. 2 and 5, a real time repricing sub-process 20 is demonstrated by example, as processed 11 on the system 10. The patient 36 has a dialogue 34 with the provider 14 concerning medical services/products, for example $1000. The patient 36 pays for a deductable 200, such as $50, as established by the system 10. The provider 14 then requests for real time EOB, EOP (processed claim 26) from the process 11 for the remainder of the claim, $950. The process 11 first routes as RT and then performs the eligibility sub-process 18 on the eligibility engine 76, for the claim data 12, and then the workflow engine 66 reroutes via RT the processing 11 to the repricing engine 62. The repricing engine 62 uses a PPO network database to reprice the claim data 12 as per preagreed contracted discounts, for example a 20% discount leaving the claim now worth $800. The workflow engine 66 then redirects the repriced claim 22 (see FIG. 1) as RT to the adjudication engine 60, which performs the adjudication sub-process 24 to determine according to adjudication rules what the related payer 30 will pay. If acceptable, then the processed claim 26, now decided as $750 to the provider 14 and $50 from the patient 36, is directed to the payment engine 74, as for example FT, for subsequent delivery to the clearing house 58 through the gateway 54, as per the payment sub-process 28. As well, the provider 14 is routed the processed claim 26 via RT through the platform 40 by the workflow engine 66. The payer 30 is also informed of the processed claim 26 through RT or FT, as agreed upon by the 11 payer 30. The various funds to cover the processed claim 26 are deposited in the related banks 72, as per the clearing house 58 payment procedure as an EFT, check, account deposit, B2B funds transfer, and other ePayment procedures. It is recognised that the processing 11 contributions of various engines 76, 62, 60, 80, 82, 74, and 84 could be combined in a number of different ways, such as a combined engine could accommodate both the adjudication and payment sub-processes 24, 28.

The repricing engine 62 is capable of performing machine to machine transactions via RT, i.e. synchronously. The software/hardware resources of the repricing engine 62 uses, for example either SOAP and/or HTTP(S) protocols and associated ports. Further, the repricing engine 62 can translate from customer-specific external formats for the claim data 12 to a common internal format, such a but not limited to AS 400. This translation of the claim data 12 includes data field mapping, right/left justification of numbers, rounding numbers to a given number of decimal points, implementation of specific business rules such as separating names in a comma-delimited field into two separate fields. The two separate fields can be used to differentiate between FT and RT messages 96 (see FIG. 4). Further, different customer mapping can be specified in an external table, instead of hard coded into the repricing engine 62 software, thereby providing a dynamic repricing sub-process 20 environment as the specific users 14, 30, 58 are updated by the system 10.

Further capabilities of the repricing engine 62 include error checking in the front end to avoid calling repricing with obviously wrong claim data 12. Other capabilities could be serialize transactions to handle single threading of the repricing engine 62, to implement serialization of the RT, FT transactions. The repricing engine 62 could also use queues, such as for example to have the workflow engine 66 running Java to communicate with the repricing engine 62 using AS 400 COBOL programs. Accepting claim data 12 from queues, a protocol could be used to read the queues and pass claim lines of the claim data 12 to the repricing engine 62 to be repriced, for example using a file interface. It is noted that insurance claims are represented by line items in the claim data 12. A further consideration for the repricing engine 62 is the transmission of the claim data 12 reliably from the workflow engine 66, which could rely upon timeout protocols to handle the cases where the repricing engine 62 goes down during the repricing sub-process 20. The repricing engine 62 also has a void/backout mechanism so that the claims 12 which the workflow engine 66 reports as time-out are backed out of any databases cooperating with the repricing engine 62, both internal and external (eg. IDB). Logging and archiving capabilities for communicating repriced claims 22 to the CFS, IDB, and CCS could also be used.

Referring to FIGS. 1, 2, and 6, it is recognised there are many ways to access the repricing engine 62, such as but not limited to online submission, batch EDI, files, and paper. Real time repricing 20 provides another way to access the repricing services. RT transactions with the repricing engine 62 can be used when payers 30 need to; send claims 12 directly from their computer to the sytem 10, and/or receive the repriced responses as processed claims 26 in real time, that is within typically seconds of the original claim data 12 submission in view of computer processing capabilities. Real Time repricing 20 is configured between the system 10 and users of the system 14, 58, 30. For example, the payer's 30 computer creates the claim data 12 in an agreed format. The claim data 12 is sent over the networks 50 to the system 10, in this case to the gateway 54. The gateway communicates the RT and FT claim data 12 for reception by the workflow engine 66, which sends the RTs and FTs to the repricing engine 62 for repricing the claim 12, in real time for RT, and fills in the repriced amount. The original claim data 12 with the addition of the repricing information is assembled as the repriced claim 22 (see FIG. 1) and sent back to the payer's 30 computer over the network 52 by the workflow engine 66 as required, such as but not limited to immediately without further processing 11.

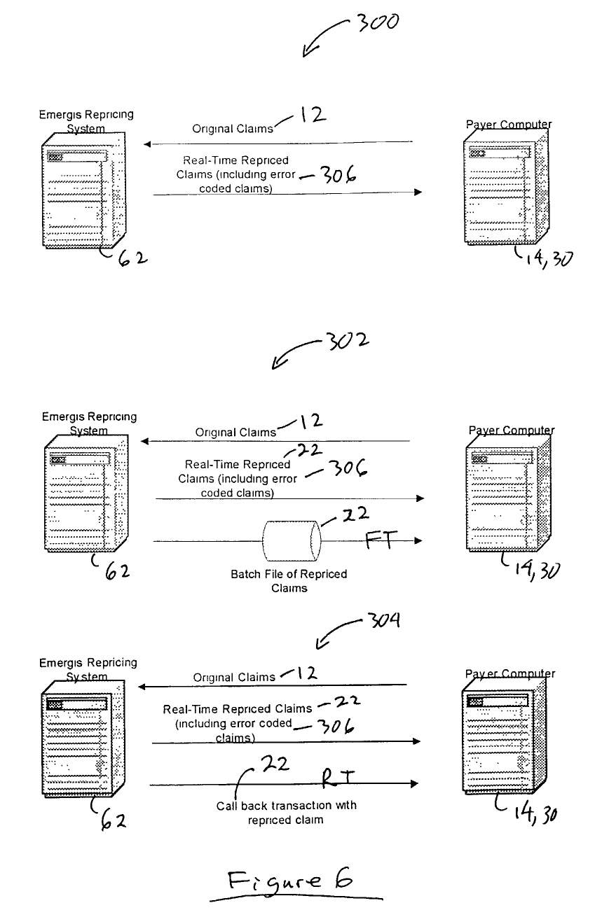

Further, the system 10 and the payer 30 (and/or the providers 14) also need to agree on how to handle claims data 12 which cannot be repriced in real time. Although the system 10 attempts to process claims automatically and in real time, there is potentially some claim data 12 that are pended and are then manually reviewed. For example, this can happen if the repricing engine 62 cannot get an automatic match on the provider identification information contained within the claim data 12. Referring to FIG. 6, there can be three options 300, 302, 304 for the payer 30 to choose from in processing the pending or manual claim; option 300 where the system 10 can return the original claim 12 in real time along with an error code 306 saying the pricing sub-process 20 cannot be done in real time, no repricing is done by the system 10 in this case, 2) option 302 where the system 10 can return the original claim 12 and error code 306 in real time but also return the repriced claim 22 later in a batch file FT transmission, in this case, the system 10 and the payer 30/provider 14 have to agree on how often to exchange FT batch files, such as once per hour or once per day, and 3) the option 304 where if the payer 30/provider 14 can provide a real time interface, the system 10 can call back to the interface and send the repriced claim 22 as an RT transaction.

Further details are as follows; for option 300 the payers 30 computer creates the claim 12 in an agreed format, the claim 12 is sent over the network 50 to the system 10, the system 10 recognizes that the claim 12 cannot be repriced in real time, and the original claim 12 information with the error code 306 is sent back to the payer's 30 computer in real time. For option 302, the payer's 30 computer creates the claim 12 in an agreed format, the claim 12 is sent over the network 50 to the system 10, the system 10 recognizes that the claim 12 cannot be repriced in real time, the original claim 12 information with the error code 306 is sent back to the payer's 30 computer in real time, the system 10 then reprices the claim 12 with some manual intervention, and then the repriced claim 22 is put the FT for the payer 30 to process in batch at agreed-to intervals. Regarding option 3, the payer's 30 computer creates the claim 12 in an agreed format, the claim 12 is sent over the network 50 to the system 10, the system 10 recognizes that the claim 12 cannot be repriced in real time, the original claim 12 information with the error code 306 is sent back to the payer's 30 computer in real time, the system 10 reprices the claim 12 with some manual intervention, and the repriced claim 22 is put in the FT file for the payer 30 to process in batch at agreed-to intervals. It is recognised that the above repricing protocols could be done with other users of the system 10, such as the providers 14.

Further, to configure and implement Real Time Repricing 20, the system and the users, such as but not limited to the payer 30, agree to the following for both real time and batch file transmissions (for option 302) or call back transactions (for option 304), namely 1) the format for the claim 12 information and response, the network 50 protocols to be used to transfer the information as RT and/or FT transactions, the security mechanisms, how to handle claims 12 which cannot be repriced in real time (concerning options 300, 302, or 304), and volumes and service levels.

Further details on file layouts and network 50 protocols are given below by example only.

Record Layout

Regardless of the network 50 protocols used, the system 10 and the payer 30 agree on the record layout for the claim 12 information. The following table shows such as but not limited to a 444 byte record layout, where one record is sent per claim line item.

Claim Line Item Record Layout

| | Field | Field | Field | Starting |
|---|---|---|---|---|
| Field Definition | Name | Type | Length | Location |
| Provider Number | PROVIDRNO | A | 7 | 1 |
| Contract Number | CONTRACTNO | A | 7 | 8 |
| Provider Zip Code | PROVZIP | A | 9 | 15 |
| Provider Specialty | SPECIALITY | A | 4 | 24 |
| Provider Type | PROVTYPE | A | 4 | 28 |
| Provider Name | PROVGRPNAM | A | 50 | 32 |
| Tax ID Number | TIN | A | 9 | 82 |
| TIN Suffix | TINSUFFIX | A | 2 | 91 |
| Claim Reference Number | CLAIMREFNO | A | 12 | 93 |
| Policy Number | POLICY | A | 10 | 105 |
| Claimant Number | CLAIMANTNO | A | 2 | 115 |
| Form ID | FORMID | A | 25 | 117 |
| Service Line ID | SVCLINEID | A | 25 | 142 |
| Document ID | DOCUMENTID | A | 10 | 167 |
| Network | NETWORK | A | 6 | 177 |
| Form Type | FORMTYPE | A | 1 | 183 |
| Claimant Name | CLAIMANTNM | A | 30 | 184 |
| Claimant Date of Birth | CLAIMNTDOB | A | 8 | 214 |
| Patient Account Number | PATACCTNO | A | 17 | 222 |
| Patient Sex | PATSEX | A | 1 | 239 |
| Bill Type | BILLTYPE | A | 3 | 240 |
| Hospital Admission Date | ADMITDATE | A | 8 | 243 |
| From Date | FROMDATE | A | 8 | 251 |
| Thru Date | THRUDATE | A | 8 | 259 |
| Relationship Number | RELATNO | A | 1 | 267 |
| Accident Flag | ACCIDNTFLG | A | 1 | 268 |
| Diagnostic Related | DRG | A | 5 | 269 |
| grouping | | | | |
| Discharge Status | DISCHGSTAT | A | 2 | 274 |
| Admitting Diagnosis | ADMITDIAG | A | 8 | 276 |
| Condition Code 1 | CONDCODE1 | A | 2 | 284 |
| Condition Code 2 | CONDCODE2 | A | 2 | 286 |
| Condition Code 3 | CONDCODE3 | A | 2 | 288 |
| Condition Code 4 | CONDCODE4 | A | 2 | 290 |
| Condition Code 5 | CONDCODE5 | A | 2 | 292 |
| Diagnosis 1 | DIAGNOSIS1 | A | 6 | 294 |
| Diagnosis 2 | DIAGNOSIS2 | A | 6 | 300 |
| Diagnosis 3 | DIAGNOSIS3 | A | 6 | 306 |
| Diagnosis 4 | DIAGNOSIS4 | A | 6 | 312 |
| Diagnosis 5 | DIAGNOSIS5 | A | 6 | 318 |
| Diagnosis Pointer | DIAGPTR | A | 1 | 324 |
| Occurrence Code 1 | OCCURCODE1 | A | 2 | 325 |
| Occurrence Code 2 | OCCURCODE2 | A | 2 | 327 |
| Occurrence Code 3 | OCCURCODE3 | A | 2 | 329 |
| Occurrence Code 4 | OCCURCODE4 | A | 2 | 331 |
| Occurrence Date 1 | OCCCDEDAT1 | A | 8 | 333 |
| Occurrence Date 2 | OCCCDEDAT2 | A | 8 | 341 |
| Occurrence Date 3 | OCCCDEDAT3 | A | 8 | 349 |
| Occurrence Date 4 | OCCCDEDAT4 | A | 8 | 357 |
| Hospital Procedure1 | HOSPPROC1 | A | 5 | 365 |
| Hospital Procedure2 | HOSPPROC2 | A | 5 | 370 |
| Hospital Procedure3 | HOSPPROC3 | A | 5 | 375 |
| Hospital Procedure4 | HOSPPROC4 | A | 5 | 380 |
| Procedure Modifier | PROCMOD | A | 2 | 385 |
| Amount Billed | AMTBILLED | A | 10 | 387 |
| Place of Service | CDPOS | A | 3 | 397 |
| Type of Service | CDTOS | A | 1 | 400 |
| Number of Units/Days | NOUNITS | A | 3 | 401 |
| Revenue Code | REVCODE | A | 3 | 404 |
| Contract Rate Amount | AMTCONRATE | A | 10 | 407 |
| Date Filed | FILEDATE | A | 8 | 417 |
| Time Filed | FILETIME | A | 4 | 425 |
| Line Number | LINENUMB | A | 3 | 429 |
| File Name | FILENAME | A | 8 | 432 |
| Office ID | OFFICEID | A | 1 | 440 |
| Line Sequence Number | LINESEQNO | A | 4 | 441 |

There could also be a set of business rules that apply to the above layout, which can include mandatory versus optional fields, and special requirements for physician versus hospital claims.

Network Protocols

The two options for network 50 application protocols, such as but not limited to, are either the Simple Object Access Protocol (SOAP) or the Hypertext Transmission Protocol/Secure-Post (HTT/S-Post). For SOAP, the payer 30 implements a capability to send and receive the agreed claims 12 record in the SOAP message 96, using the SOAP port 130 (see FIG. 4). The system 10 uses a URL, a URI (Qname), and a Service Name as part of the implementation process. SOAP implementation will use SOAP messaging facilities on the payer 30 system to communicate with the system 10 SOAP systems, such as the workflow engine 66. For HTTP-S/Post, the payer 30 implements a capability to send and receive messages encrypted using 128 bit Secure Sockets Layer (SSL) using HTTP/Post. The following table shows an XML messages that can be used to send and receive the RT claim 12 information. The system 10 can also use the URL for HTTP/S-Post as part of the implementation process.

For HTTP/Post, The following table gives an example messages 96 format:

Sender's request Format :
<Claim>
<LineItem>
// 444 byte data record
</LineItem>
<LineItem>
// 444 byte data record
</LineItem>
.....
<payor> payer id </payor>
<password>xxxxxxx</password>
</Claim>
Response Format :
1) Normal case :
<Data> repriced 444 byte record</Data>
2) Error case
<Data> <error code> </Data>

For option 302, where batch FT files are used to handle claims 12 which cannot be repriced automatically, the system can use the Internet File Transmission Protocol (FTP) formats and ports 132. For option 304, where the payer 30 provides a call back transaction interface for claims 12 which cannot be repriced automatically, the system 10 can use the standard internet protocols such as HTTP-S/Post or SOAP for the RT transactions. Further, it is noted that under certain circumstances, the RT repricing application can return an error code. One approach is to return the error code as the only field in an error record, but other layouts can also be used if desired. It is envisioned that the error code details depend on the repricing business relationship between the payer 30 and the system 10, and so an error code list could be provided as part of the detailed implementation process done as prearranged prior to the payer 30 using the system 10.

The following is an example implementation for performing the operation of the the system 10 and processing 11 as given above, where the Function defines a step in the process 11, the Step outlines the sequence, the Actor defines the component 52 and/or system 10 user implementing the particular step, and the Pilot Business Team describes the operations taking place in the particular steps.

| Function | Step | Actor | Pilot Business Team |
|---|---|---|---|
| Submit | 1 | Provider | Submits claim using the portal 47. There is no paper |
| Claim 12 | | 14 | claim processing for the provider 14. |
| | | | To assist the provider 14 and to reduce the amount of |
| | | | rekeying, the portal 47 application will have access to |
| | | | enrollment data and previous claims to locate member |
| | | | and patient 36 data and to pre-populate as many fields as |
| | | | possible. |
| | | | Payers 30 can also use web to submit claims12, such as |
| | | | but not limited to pay the provider 14 |
| | 2 | Integration | Receives the claim 12 |
| | | Platform | Performs level 1 edits for error checking. |
| | | 40 | |
| | 3a | Integration | Creates a RT repricing transaction and submits this to |
| | | Platform | the repricing Engine 62 |
| | | 40 | |
| | 4a | Repricing | Reprices the transaction and sends back a response |
| | | Engine 62 | |
| | 5a | Integration | Creates the claim 22 and submits this to the adjudication |
| | | Platform | engine 60 |
| | | 40 | |
| | 6 | Engine 60 | Adjudicates and sends back the response 26. |
| | 7 | Integration | Updates the Central Data Store with the claim |
| | | Platform | |
| | | 40 | |
| | 8 | Integration | Creates and sends the response 26 to the portal |
| | | Platform | application 44, 47, 54 |
| | | 40 | |
| | 9 | Portal 44, | Displays the EOB (Repricing and adjudication results) |
| | | 47 | to the provider 14. |
| | 10 | Provider | Prints the EOB and gives this to the patient 36. |
| | | 14 | |
| | 11 | Provider | Collects the amount owing by the patient 36 directly |
| | | 14 | from the patient 36, if needed. |
| | 3b | Integration | If the Level 1 edit checks do not pass, creates and sends |
| | | Platform | the rejection response 27 back to the portal application. |
| | | 40 | |
| | 4b | Portal 44, | Display the reject message 27 |
| | | 47 | |
| | 5b | Provider | Fixes the error in the original claim 12 and resubmits to |
| | | 14 | go back to step 2. |
| Void | 1 | Provider | Uses the portal 47 to select the claim 12 to void. The |
| Claim | | 14 | provider 14 can only void a claim 12 that has not be sent |
| | | | for payment. The portal 47 will be able to tell if a claim |
| | | | 12 is sent for payment, because the claims 12 it will use |
| | | | are located in the claims store CCS. If the provider 14 |
| | | | needs to void a claim 12 that has already been paid, |
| | | | please see step 8. |
| | 2 | Integration | Receives the void request |
| | | Platform | |
| | | 40 | |
| | 3 | Integration | Translates and sends this to the engine 60 |
| | | Platform | |
| | | 40 | |
| | 4 | Engine 60 | Processes the request and sends back the results 26 |
| | 5 | Integration | Receives the results 26 |
| | | Platform | |
| | | 40 | |
| | 6 | Integration | Translates and send the results 26 to the portal 47 |
| | | Platform | |
| | | 40 | |
| | 7 | Portal 47 | Produces a confirmation to the provider 14 |
| | 8 | Portal 47 | If the provider 14 has selected a claim 12 to void that |
| | | | has already been paid, the portal 47 displays a message |
| | | | to call the helpdesk |
| | 8 | Provider | Calls the pilot helpdesk (which is the Admin team 42). |
| | | 14 | |
| | 9 | Admin | The Admin team 42 debits the provider 14 by entering |
| | | Team 42 | records manually in the central claim store CCS. These |
| | | | transactions are collected as part of the payment run. |
| | | | The admin team 42 uses the repricing terminals of the |
| | | | repricing engine 62 to reverse the repricing transaction |
| | | | 20. The admin team 42 uses the engine 60 terminals to |
| | | | reverse the claim adjudication |
| Check | 1 | Provider | Submits an eligibility request using the Portal 47 |
| Eligibility | | 14 | |
| | 2 | Integration | Receives the request |
| | | Platform | |
| | | 40 | |
| | 3 | Integration | Translates and send the eligibility request to the engine |
| | | Platform | 60 |
| | | 40 | |
| | 4 | Engine 60 | Processes the eligibility request and send a response 26 |
| | | | back |
| | 5 | Integration | Translates and Returns a message 96 to the Portal |
| | | Platform | 47 application |
| | | 40 | |
| | 6 | Portal 47 | The Portal 47 application displays the results to the |
| | | | Provider 14 |
| | 7 | Provider | The provider 14 prints the Eligibility request for their |
| | | 14 | files and/or prints a copy for the member. |
| Pended | 1 | Portal 47 | Follow Claim processing Step 1 and Step 2: If the claim |
| Claim | | | could not be repriced or adjudicated, an EOB cannot be |
| | | | produced. |
| | | | The Portal 47 displays an acknowledgement to the |
| | | | provider 14. (The acknowledgement looks like an EOB, |
| | | | except the claim is pended. And it includes sufficient |
| | | | details for the provider 14 and the member to understand |
| | | | the pended claim process.) |
| | 2 | Provider | Prints the acknowledgement and gives this to the patient |
| | | 14 | 36 |
| | 3 | Integration | Once per day (or on a preset schedule) a report of |
| | | platform | pended claims 12 is generated and made available to the |
| | | 40 | payer 30 on the FTP site. |
| | 4 | Payer 30 | Picks up the report and prints the report. Then, for each |
| | | | pended claim, the payer 30 retrieves the claim 12 in the |
| | | | engine 60 and completes the claim 12. (There may be |
| | | | additional information collected, and this process may |
| | | | take more than one day.) |
| | | | If the claim 12 is pended in the repricing engine 62 (this |
| | | | should be an exception) the payers 30 contact the Admin |
| | | | support team 42 to complete the claim repricing 20. |
| | 5 | Admin | Resolves repricing issues. Repricing issues should not |
| | | Team 42 | occur as part of the normal business process. This is |
| | | | because the provider 14 selection has contracts that |
| | | | enable repricing in real-time. This would therefore be an |
| | | | exception condition. |
| | 6 | Engine 60 | Once per day (or other selected cycle), and before the |
| | | | payment cycle, the engine 60 creates a list of claims that |
| | | | have been pended and are now adjudicated. This file is |
| | | | the asynchronous claim results, i.e. FT. |
| | 6 | Integration | Before the payment cycle, the integration platform 40 |
| | | Platform | picks up this FT file from the engine 60 and reconciles |
| | | 40 | against the central data store IDB. |
| | 7 | Integration | Generates the EOB file for members of claims 12 that |
| | | platform | were asynchronously adjudicated and places this file on |
| | | 40 | the Admin FTP site. |
| | 8 | Admin | The next morning, the Admin Team picks up the EOB |
| | | team 42 | file, prints the EOBs and places them in envelopes to be |
| | | | mailed. There is one copy for the provider 14 and one |
| | | | for the member |
| | 9 | Provider | Receives the EOB and bills the member for their |
| | | 14 | portion. The provider 14 will receive the payer's 30 |
| | | | portion through the regular payment process. |
| | 10 | Member | Receives the EOB and pays the provider their portion. |
| Payment | 1 | Integration | Every “night”, a payment file is created. This file is the |
| | | platform | EFT payments to be made. The process consolidates all |
| | | 40 | payments for one provider 14 creating at most one |
| | | | payment for each provider 14. If there are negative |
| | | | amounts due to prior day voids, these are subtracted |
| | | | from the amount owed to providers 14. If there are |
| | | | discounts, these are subtracted from the amount owed to |
| | | | the provider 14. |
| | | | A day end process is run that marks the engine 60 |
| | | | transactions in the engine 60 database to “Paid”. These |
| | | | transactions are reconciled against the central store |
| | | | CCS. Then a file is created of EFT/ACH payments to be |
| | | | made. |
| | 2 | Integration | Delivers the file to a payment Vendor 58 |
| | | platform | |
| | | 40 | |
| | 3 | Payment | Processes the EFT payments |
| | | vendor 58 | |
| | 4 | Payment | Returns a confirmation file |
| | | vendor 58 | |
| | 5 | Integration | Receives the file and updates the central claim store |
| | | platform | CCS with the confirmation results. |
| | | 40 | |
| | 6 | Integration | Creates a list of problems and delivers the list of |
| | | platform | problems to the Admin team 42. The list of problems |
| | | 40 | includes payments that did not get processed by the |
| | | | bank 72, plus any items in the database that cannot be |
| | | | sent to the bank 72 (because they are missing data, or |
| | | | because of internal error.) |
| | 7 | Admin | Picks up problem file |
| | | Team 42 | |
| | 8 | Admin | Cuts a manual check for that provider 14. |
| | | Team 42 | Updates the problem file with the check number |
| | | | Passes the problem file back to the EFT point |
| | 9 | Integration | Picks up the problem file with the check numbers |
| | | platform | Updates the Central provider store86 with the results |
| | | 40 | |
| Provider | 1 | Provider | Submits an inquiry using the portal 47 |
| Reconciliation | | 14 | |
| | 2 | Portal 47 | Produces a reconciliation screen, by looking at claims |
| | | | 12 in the central data store IDB |
| Coordinate | 1 | Portal 47 | This is done in the Central Data store IDB. The claims |
| Claims | | | 12 are coordinated at each of the following points |
| | | | When a claim 12 is transmitted or voided |
| | | | When an asynchronous file FT is received from the |
| | | | engine 60 |
| | | | When an asynchronous file FT is received from |
| | | | Repricing engine 62 |
| | | | When the payment file is produced |
| | | | When the confirmation file is received |
| | | | When the manual checks are created |
| | | | (These processes are already covered under previous |
| | | | sections, but are repeated here to clarify where the |
| | | | coordination points are between claims in the distributed |
| | | | systems and claims 12 in the central data store IDB.) |
| | 2 | Integration | As part of the nightly run, the claims 12 are extracted |
| | | platform | and provided to Admin team 42 |
| | | 40 | |
| | 3 | Admin | Admin Team 42 picks up the file from the FTP site and |
| | | Team 42 | loads claim into a local tool (such as Excel.) The |
| | | | purpose is to provide data for billing, audit and analysis. |
| Send Data | 1 | Integration | A daily file of claims 12 is produced by the system 10 |
| to Payer | | platform | and delivered to a payer FTP site. |
| | | 40 | |
| Share | 1 | Integration | This can depend on the payer 30, employer and plans |
| Limits | | platform | selected. |
| | | 40 | |
| Audit | 1 | Admin | the Administrators 42 can use the data provided (see |
| Claims | | Team 42 | Coordinate Claims Step 2 & 3) to look for suspect |
| | | | claims 12. |
| Inquiry | 1 | Provider | To review past claims 12, to reconcile or to reproduce |
| | | 14 | an EOB, the provider 14 uses the portal 47. |
| | 2 | Provider | If the provider 14 has a problem, they should call the |
| | | 14 | Pilot helpdesk (Admin Team 42.) |
| | 3 | Payer 30 | If the payer 30 has a problem, they should call the Pilot |
| | | | helpdesk (Admin Team 42.) |
| | 4 | Patient 36 | If the patient 36 has a problem, they should call the |
| | | | Payer 30 helpdesk (Admin Team 42.) |
| Bill Payer | 1 | Admin | Using the data provided (see Coordinate Claims Step 2 |
| | | Team 42 | & 3,) create and send an invoice to the payer 30 for |
| | | | transactions processed plus the provider 14 discounts. |
| | | | There will be a daily bill to recoup funds that were paid |
| | | | out and a monthly bill of transactions charges and |
| | | | administration charges. |
| | 2 | Admin | Create and send an invoice to the payer 30 for EFT/ACH |
| | | Team 42 | payments made |
| Monitor | 1 | Admin | Is the central point of contact |
| System | | Team 42 | Communicates problems to the Providers 24, Business, |
| | | | Development Team, Payment Vendor 58 as needed. |
| | 2 | ONS | Conducts routine checks |
| | | | Report any system errors to the central point of contact. |
| | | | Responds to problems brought to their attention |
| | 3 | Payment | Report any system 10 errors to the central point of |
| | | Vendor 58 | contact. |
| | | | Responds to problems brought to their attention |
| | 4 | Tech Team | Responds to problems brought to their attention |
| Maintain | 1 | ONS | Minimal security changes are expected. If they occur, |
| Security | | | they are handled manually. |
| Maintain | 1 | Admin | Minimal provider 14 changes are expected. If they |
| Providers | | team 42 | occur, they will be entered manually into the repricing |
| 14 | | | engine 62 and the engine 60. We will try to avoid |
| | | | rekeying into engine 60 by working with “artificial” |
| | | | providers in engine 60. |
| Maintain | 1 | Admin | Minimal plan changes are expected. If they occur, they |
| Plans | | Team 42 | are entered directly into the engine 60. |
| | | or Payer | |
| | | 30 | |
| Maintain | 1 | Payer 30 | A daily file load of enrollment data is sent from the |
| Members | | | payer 30 to the system 10. |
| | 2 | Integration | Detects the enrollment file. |
| | | Platform | Loads the enrollment data into the central file store CFS |
| | | 40 | Generates and sends an upload file to the engine 60 |
| | 3 | Engine 60 | Incorporates enrollment data into the engine 60 |
| | | | Creates a reject file of records that could not be |
| | | | processed. |
| | 4 | Integration | Receives a file of enrollment rejects and passes these to |
| | | platform | the payer 30 |
| | | 40 | |
| | 5 | Payer 30 | Receives the enrollment rejects and takes appropriate |
| | | | action. |

Accordingly, the system 10 helps to provide; the settling of claims 12 in real time, to track the claim 12 as it is processed through the various eligibility 18, repricing 20, adjudication 24, and payment 28 processes; as well as to increase electronic processing of the claims 12 as compared to paper processing. The system provides claims 12 submission (web enabled/EDI integrated with PMS 56), patient 36 eligibility 18, network claims repricing 20, rules-based, data driven claims adjudication 24, electronic claims payment 28, data warehousing in the IDB, reporting and inquiries, and security and privacy 64. Further, it is recognised the system 10 can allow the provider 14 to know the patient 36 payment amount before the patient 36 leaves the provider's 14 premises. This capability can give the leverage to the health plan as administered by the payer 30 to pay the provider 14.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A real time claim processing system, the system comprising: a) an electronic claim submission interface; b) an eligibility processor of claim data supplied through the claim interface; c) a repricing processor for repricing the claim data; d) an adjudication processor for adjudicating the repriced claim data to provide adjudication details; e) and a payment processor for providing payment details of the adjudicated claim; wherein a real time response is provided to a provider of the claim data supplying adjudication and payment details.
